(19) United States
(12) Patent Application Publication
(10) Pub. No.: US 2007/0236921 A1
(43) Pub. Date: Oct. 11, 2007

(54) Solar powered underwater multipurpose illumination device

(75) Inventors: D. Michael Mosholder JR., East Lansing, MI (US); Jeffrey T. Beach, Williamston, MI (US)

Correspondence Address: BUCHANAN, INGERSOLL & ROONEY PC, POST OFFICE BOX 1404, ALEXANDRIA, VA, 22313-1404, US

(73) Assignee: Aqua-Glo, LLC, Lansing, MI (US)

(21) Appl. No.: 11/606,230

(22) Filed: Nov. 30, 2006

Related U.S. Application Data
(63) Continuation-in-part of application No. 10/857,500, filed on Jun. 1, 2004.

(51) Int. Cl. F21V 31/00

(52) U.S. Cl. 362/158; 362/312

(57) ABSTRACT

An illumination device includes a housing and a lens disposed at the end of the housing. The lens is in watertight engagement with the housing and includes at least one LED disposed in the housing and for transmitting light through the lens. An infrared sensor is operatively connected to the electronic control unit for remotely operating the electronic control unit. The illumination device also includes a mounting disk and bracket for mounting to underwater surfaces, such as a pool, or a magnet for the same. An electronic driver unit regulates power to the LED module, thereby saving battery power.

This application is a continuation in part of, and claims priority to, U.S. patent application Ser. No. 10/857,500, filed on Jun. 4, 2004, the contents of which are incorporated herein.

### FIELD OF THE INVENTION

The present invention relates to illumination systems. More particularly, the present invention relates to solar powered underwater illumination systems.

### BACKGROUND OF THE INVENTION

Many devices have been proposed for illuminating bodies of waters, such as pools.

Prior art systems include the use of electrical units installed directly in a pool lining underground. For example, U.S. Pat. No. 6,184,628 discloses a pool light for mounting in a cavity of the pool below the water surface. A 12 volt-ac power source is provided for supplying power to the light source. However, there are many disadvantages in connection with these underground systems. With regard to internal light sources, strong electrical currents are often used to operate these systems. In addition, specialists are needed to install the systems to avoid underwater shock and electrocution. Further, specific regulations must be followed in order to provide against underwater shock and electrocution. For example, electrical cable lines have to be buried underground. These types of installations can be very costly, and the risk of electrocution is never totally eliminated.

Another drawback involved in the preceding examples relates to power source. There are drawbacks, as noted above, with lights that must be wired to an external power source, e.g., live wires in the vicinity of the pool, batteries, or electrical outlets within the lighting unit. Lights that require batteries need to have the batteries changed/charged frequently. Thus, either an electrical connection to the light must be provided, or an opening to insert/remove the batteries for charging/replacement must be provided. The electrical connection or opening jeopardize the water tightness of the light. If water gets into the light, the internal components of the light will likely be damaged, thereby preventing the light from operating properly.

With all those drawbacks in mind, the present application discusses a solar powered light.

### SUMMARY

An illumination device, comprising: a housing defining an outer surface, the outer surface defining a space therein, the housing comprising a lens, the housing and the lens being configured so that light can travel from outside the housing to the space and from the space to the outside of the housing, and so that the space in the housing is impervious to water from the outside; at least one LED disposed in the space, the at least one LED for transmitting light through the lens to outside the housing; a rechargeable battery within the space; a solar unit within the space, for generating electricity from solar energy for providing power to the rechargeable power source or the LED; and an electronic control unit within the space, the electronic control unit for directing power from the battery or the solar unit to the at least one LED; a signal sensor within the space, the signal sensor being operatively connected to the electronic control unit for remotely operating the electronic control unit; a first magnet integrated with the housing, wherein the LED, battery, electronic control and solar panel are electrically self contained and have no electrical connection from inside the space to outside the space, and wherein the housing is configured to not have a position providing an opening connecting the space inside the housing to the outside space.

### BRIEF SUMMARY OF THE DRAWINGS

The accompanying drawings provide visual representations which will be used to more fully describe the representative embodiments disclosed herein and can be used by those skilled in the art to better understand them and their inherent advantages. In these drawings, like reference numerals identify corresponding elements and:

FIG. 1 is a cross-sectional view of an exemplary embodiment of the present invention;

FIG. 2 is a top plan view of an exemplary embodiment of the present invention;

FIG. 3 is a side elevational view of the mounting disk and bracket of an exemplary embodiment of the present invention;

FIG. 4 is a perspective view of the lens according to an exemplary embodiment of the present invention;

FIG. 5 is a cross-sectional view of the lens of FIG. 4; and

FIG. 6 is a perspective view of the lens, with portions taken away, of an exemplary embodiment of the present invention showing how light is refracted through the lens;

FIG. 7 is a side view cross section of a solar powered embodiment including a magnet.

### DETAILED DESCRIPTION OF THE PREFERRED EMBODIMENTS

With reference to the figures, exemplary embodiments of the present invention will now be described. The scope of the invention disclosed is applicable to uses in addition to illuminating swimming pools. For example, the present invention is also applicable to illuminating other underwater areas such as docks and underwater landscaping features. The device may also be used for other recreational activities, such as camping and backyard illumination, where imperviousness to water and moisture is required.

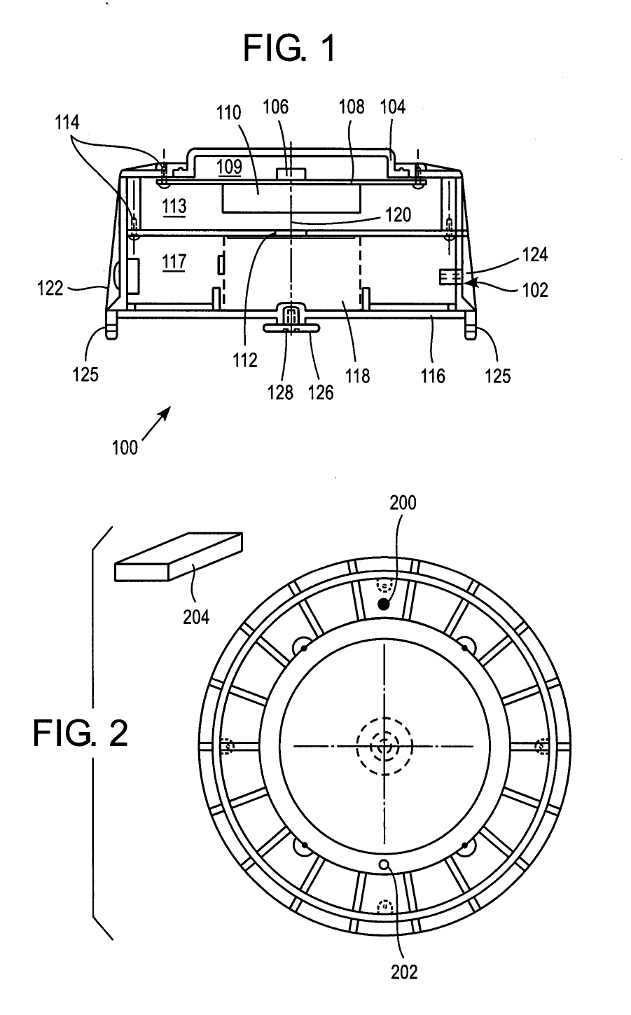

FIG. 1 illustrates a cross-sectional view of an illumination device 100 according to an exemplary embodiment of the present invention. One embodiment of the illumination device 100 includes a main housing 102 with a lens 104 disposed at the end of the housing 102. The lens 104 is in watertight engagement with the main housing 102, thereby defining a watertight area 103. Preferably, both lens 104 and main housing 102 are made from a plastic material, and are sonic welded together. However, it should be understood that main housing 102 and lens 104 can be made from any other material that is resistant to water and water corrosive effects. In addition, it should be understood that main housing 102 and lens 104 may be connected in other ways known in the art, such as by a waterproof adhesive or mechanical fasteners. A seal (not shown) may be placed between the hosing 102 and the lens 104 to help establish a watertight compartment 107 therein.

The illumination device 100 includes an LED module 106 for illuminating the device. The LED module is made up of at least one LED bulb. Preferably, the LED module 106 emits a white light. Alternatively, the LED module 106 may emit a plurality of different color lights, such as red, green and blue lights. However, the LED module 106 is not limited to these color selections. Preferably, the LED module 106 is 0.5 mm in diameter by 0.200 mm in height. However, different size and shape LED modules may also be used, depending on design preference.

The LED module 106 is disposed in the watertight area 107 defined by the housing and the lens 104. The LED module 106 is positioned to allow transmission of light through the lens 104. The LED module 106 is mounted behind the lens 104 on an electronic mounting plate 108, in a first compartment 109. Mounted on the opposite side of the electronic mounting plate 108 is an electronic control unit 110.

A divider plate 112 is disposed adjacent to, but spaced from the electronic mounting plate 108 thereby defining a second compartment 113. Preferably, the divider plate 112 and electronic mounting plate 108 are attached to the housing 102 via a plurality of screws 114, which are disposed underneath the sonic weld and inside the main housing 102. However, it should be understood that the divider plate 112 may be attached in other ways, such as by an adhesive or through bonding.

A backup plate 116 is disposed adjacent to, but spaced from the divider plate 112 thereby defining a third compartment 117. A power source 118 is disposed between the divider plate 112 and the backup plate 116 in the third compartment 117. The divider plate 112 includes an aperture 120 for directing wires from the power source 118 to the electronic control unit 110.

Preferably, the power source is at least one battery, or a plurality of batteries, that are rechargeable. According to a preferred embodiment, the batteries are nested in a straight line next to one another. However, it should be understood that the batteries may be arranged in other ways known in the art.

A solar unit 109 for transforming solar energy into electric charge may be provided in this embodiment and is preferably a solar panel. The solar unit 109 can be positioned anywhere on the outside of the lens 104 or housing 102, and can alternately be positioned inside the watertight compartment 107. It is necessary that the solar unit 109 be able to receive light energy from an outside source, e.g., the sun, when exposed.

The illumination device 100 may also optionally include an on/off button 122. The on/off button 122 is disposed on the side of the housing 102, but may be disposed in any other location. Preferably, the on/off button 122 is rubberized, and is designed to be resistant to water. In an alternative embodiment, a magnetic reed switch can be used instead of the disclosed on/off button.

A mounting magnet 608 can be provided on the backside of the illumination device 100 and is preferably connected with the housing 102. The magnet is for creating magnetic connection with an object, e.g., a metal object, wall, or other member, thereby holding the illumination device 100 in place with respect to that object. Preferably, the object is a metal wall of a pool, e.g., an above ground pool, but can also be another magnet that is secured to a structure. That configuration is particularly advantageous in that only the illumination device 100 is needed to establish a connection to locate and maintain the illumination device 100 in a position bellow the surface of the pool. The illumination device 100 is capable of being submerged underwater to provide diffused light to that body of water.

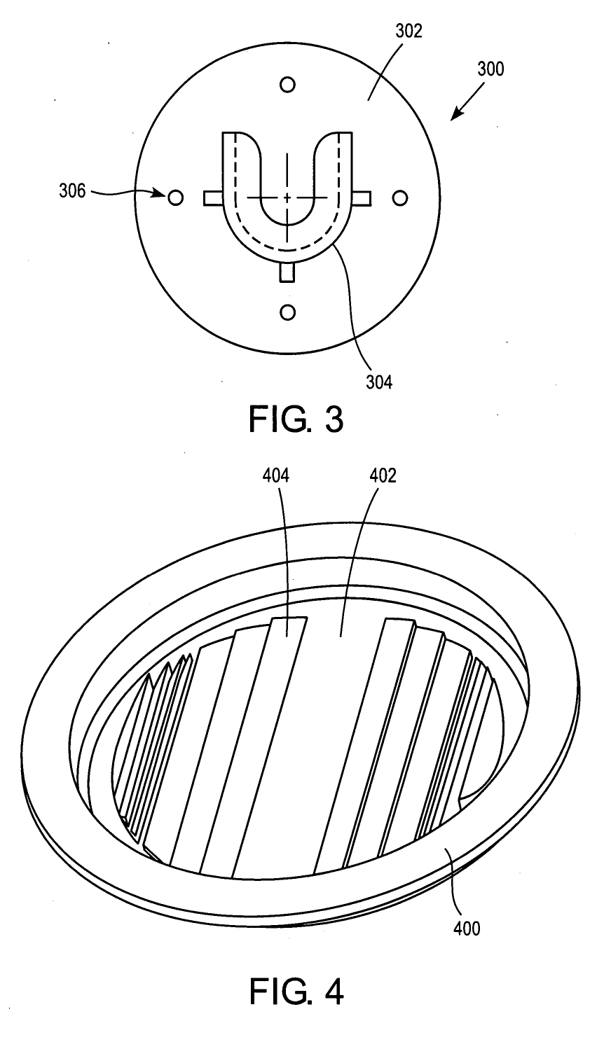

With reference to FIG. 2, an IR sensor 200 is provided. The IR sensor 200 is operatively connected to the electronic control unit (FIG. 1), for remotely operating the electronic control unit. In particular, a remote control unit, such as one used for keyless entry into a car, can activate the infrared sensor 200 to turn the LED module on and off.

In the preferred embodiment, the infrared sensor 200 is disposed behind the lens. According to a preferred embodiment, the remote control 204 is operable with the infrared sensor 200 to remotely operate the electronic control unit that directs power from the power source for illuminating the LED module 106.

According to an alternative embodiment, the LED module 106 emits a plurality of colors. According to this embodiment, the remote control 204 is operable with the infrared sensor 200 to change the color of the LED module 106. In a preferred embodiment, the remote control 204 determines the pattern of light emitted by the LED module 106. For example, for a white light, the remote control 204 can be pushed a first time. For a blue light, the remote control may be pushed a second time. For a red light, the remote control is pushed three times. For a green light, the remote control is pushed a fourth time. To turn the light off, the remote control is pushed a fifth time. However, one having ordinary skill in the art will recognize that there are numerous ways to change the colors and patterns of the LED module. For example, the LEDs can be arranged and configured so that they can display the temperature of the water, in conjunction with a thermometer, and display the time, in conjunction with an internal clock.

In the event that the remote control 204 is not available, the control unit may be controlled by the on/off button 122. The on/off button 122 can be a rubber button that is integrated with the housing, so as to maintain water tightness of the housing 102.

Optionally, the illumination device may also include a charge indicator light 202 which changes between a green and red color. When the power source is running low, the charge indicator light will become red. When the power level is sufficient, the charge indicator will remain green. Preferably, the charge indicator is a 0.200 RG LED which changes from red to green.

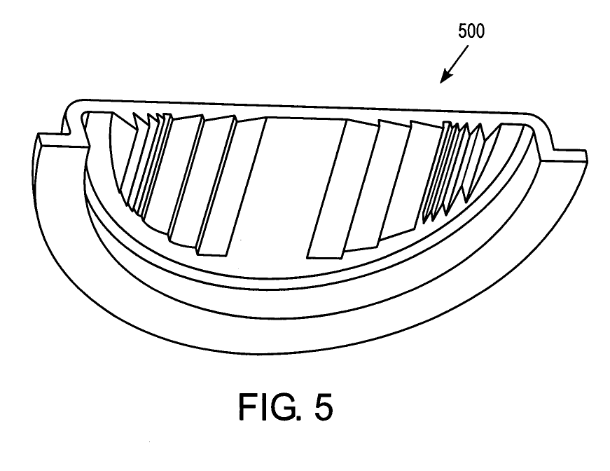

With reference to FIG. 3, the illumination device may be mounted to a surface via a mounting bracket 300. The mounting bracket 300 includes a plate 302 with a U-shaped bracket 304 mounted thereon. The plate 302 and U-shaped bracket 304 may be formed integrally, or formed separately and then mounted together permanently. Plate 302 allows for the mounting bracket 300 to be connected to a surface, such as a pool surface. Preferably, the mounting bracket 300 is attached to a surface via screws (not shown) which are mounted through a plurality of holes 306. Alternatively, the mounting bracket 300 may be affixed to a surface via a two-part epoxy. When mounting the illumination device to a wet surface, a two-part epoxy may be used that can be applied underwater. The mounting disk 126 comes in different sizes to compensate for varying diameters in pools.

With reference to FIGS. 1 and 3, the illumination device 100 is mounted onto the mounting bracket 300 by way of the mounting disk 126. In particular, the mounting disk 126 enters and is supported by the U-shaped bracket 304, such that the disk rests securely within the U-shaped bracket 304. In order to remove the illumination device 100 from the mounting bracket 300, the illumination device 100 and mounting disk 126 is simply moved upward out of the U-shaped bracket. The device can be mounted to the side of any surface using the mounting disk and mounting bracket and/or an underwater epoxy system. For example the illumination device may be mounted to the side of a swimming pool, on a boat or a dock. In addition, the illumination device may be mounted on trees or other surfaces for camping and backyard illumination including landscaping features.

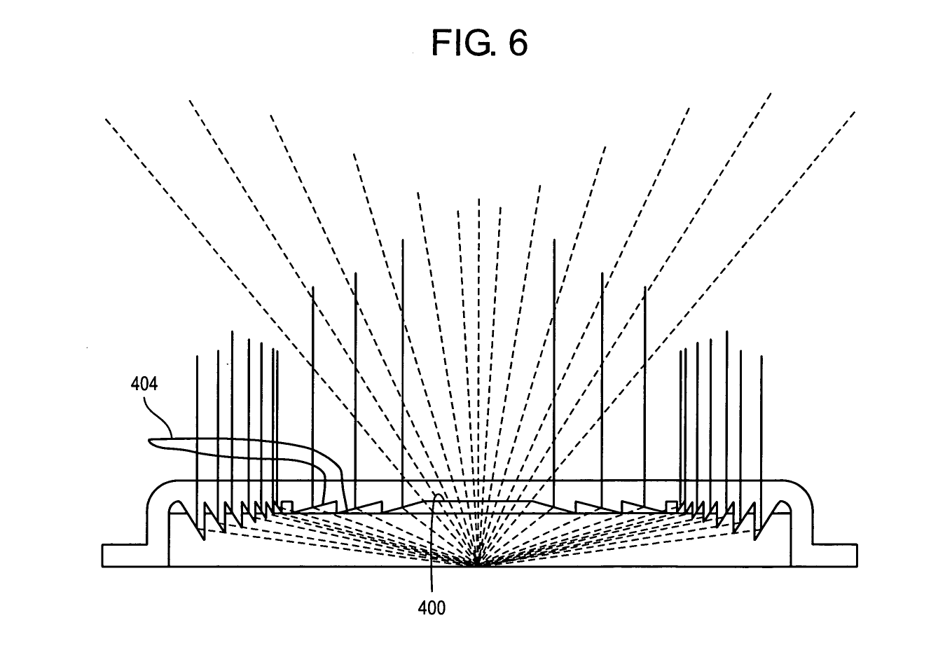

With reference to FIGS. 4-6, the preferred embodiment of the lens 400 includes a relatively planar front surface 402. Preferably, the center of the lens is relatively flat, to refract light at various angles, as shown in FIG. 6. However, the lens 400 includes a plurality of ridges 404, which are angled from the front surface 402. The ridges 404 are shaped so as to emit light at an angle perpendicular to the front surface of the lens 400, as shown in FIG. 6. FIG. 5 shows a perspective view of the lens 500 divided in half, showing the landscape of the ridges. The shape of the lens maximizes the light emitted to the pool by directing most of the light rays perpendicular from the front surface so that the light is directed sidewardly. In addition, the front surface or center of the lens remains so as to also emit light downwardly.

In one embodiment, the lens is designed to emit the light in downward horizontal directions, in order to keep as much light as possible in the pool.

The illumination device of the present invention also includes a restrictor chip or electronic driver that regulates the battery to give only the required amount of milliamps to operate the LED module efficiently. The electronic driver is mounted behind the LED module inside the electronics mount.

In another embodiment, the housing 102 may include slots 125 extending through the base. The slots 125 enable the housing to be fastened to a tree, pole, object, magnet, or other surface with a strap.

Another embodiment includes a series of small diodes to indicate to a user the temperature of any water that the illumination device is submerged in. The lights indicating the temperature may flash on/off, and may flash at predetermined intervals. They can be controlled by the IR signals.

The present device is safe, using rechargeable batteries with no risk of fire or electrocution through external electrical currents. The illumination device of the present invention provides multiple uses for underwater illumination inexpensively. It also offers convenience with remote control access to operations.

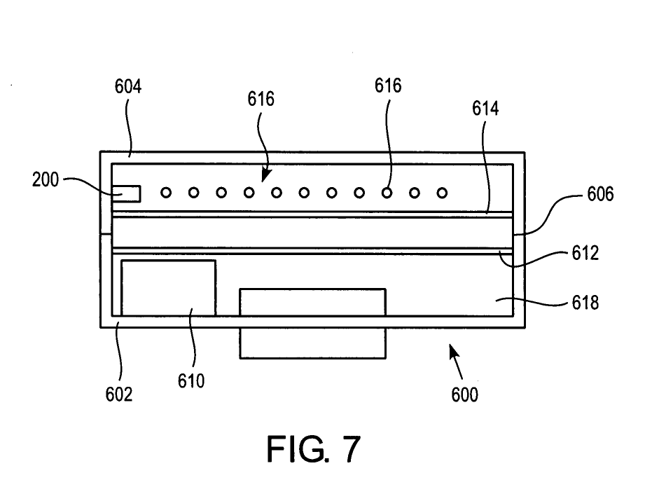

In another embodiment, which can include all compatible aspects from the previously mentioned embodiments, the solar power aspects, magnetic connecting aspects, and watertight aspects of the system provided are elaborated upon. FIG. 7 shows a side cross-sectional view of a solar powered light that is watertight. The first outer casing part 602 is configured to connect to the second outer casing part 604, thereby defining an outer surface that defines an inner open space 618 therein. The first outer casing part 602 and the second outer casing part 604 are connected to one another so that water cannot travel between the inner open space 618 and space outside the light 600. The second outer casing 604 comprises a part that is at least partially transparent to light (e.g., a lens), thereby allowing light from outside the light 600 into the inner open space 618. Preferably, the second outer casing 604 is transparent. The connection between the first outer casing part 602 and the second outer casing part 604 can be formed by any known means. However, some of the more preferred are welding, gluing, or epoxy. A preferred method of welding is vibratory welding, however, any method of welding can be used.

Inside the light 600 are a number of components as described above. Their positions can vary as needed. A magnet 608 is connected to the light 600. The magnet 608 can be provided on the inside of the first outer casing part 602, on the outside of the first outer casing part 602, or inside/part of the outer casing part 602. The magnet could also be connected to the bracket 128. An important factor in the placement of the magnet 608 is that the watertight integrity of the light 600 be maintained.

A rechargeable battery is provided in the light 600, preferably within the open space 618. However, that battery can be provided anywhere so long as the watertight integrity of the light 600 is maintained.

A controller 612 is provided in the light 600, and is preferably an electronic control board. The controller 612 can be positioned above the magnet 608.

A solar panel 612 is provided in the light 600 and is positioned so as to receive light from the exterior of the light. The solar panel 612 is electrically connected to the battery 610 so that the electricity generated by the solar panel 612 can charge the battery 610.

An LED 616 is provided inside the light 600. The LED 616 can alternatively me numerous LED's. The LED's can be configured in any known manner, and controlled by the controller 612 to be turned on/off in any sequence or order. The LED's can be used to display information by turning on/off in an appropriate order, according to the controller 612. The LED can receive power from the battery 610, directly from the solar panel 614, or from a combination of both. The LED is preferably positioned inside the light 600, and in the inner open space 618, above the solar panel 614 so that it is visible through the transparent portion of the second outer casing part 604.

A thermometer can me incorporated in the light 600. A clock can also be incorporated in the light 600. The temperature and the time can be displayed with the LED's in conjunction with the controller.

The magnet 608 can be magnetically connected to a piece of metal thereby securing the metal, and in turn, to what ever structure the piece of metal is connected to. Also, the magnet 608 can be magnetically connected to another magnet 609 by magnetic attraction. The magnet 609 can be connected to a surface, preferable a solid surface such as the inside of a pool, or other underwater structure. The magnet 609 can be connected to the structure by epoxy, glue, straps, screws, bolts, brackets, or any other known connecting means. The light 600 can be held in page underwater by connecting the magnet 608 to the magnet 609 by magnetic attraction.

A detector is provided for detecting signals. The signals instruct the controller 612 to perform operations, such as, on/off, display time, temperature, etc., and frequency of display, e.g., flashing at predetermined times. A preferred signal detector detects infra red signals. Alternatively, the detector can detect radio waves, or sound waves.

The presently disclosed embodiments are considered in all respects to be illustrative and not restrictive. The scope is indicated by the appended claims, rather than the foregoing description, and all changes that come within the meaning and range of equivalence thereof are intended to be embraced.

What is claimed is:

1. An illumination device, comprising:
a housing defining an outer surface, the outer surface defining a space therein, the housing comprising a lens, the housing and the lens being configured so that light can travel from outside the housing to the space and from the space to the outside of the housing, and so that the space in the housing is impervious to water from the outside;
at least one LED disposed in the space, the at least one LED for transmitting light through the lens to outside the housing;
a rechargeable battery within the space;
a solar unit within the space, for generating electricity from solar energy for providing power to the rechargeable power source or the LED; and
an electronic control unit within the space, the electronic control unit for directing power from the battery or the solar unit to the at least one LED;
a signal sensor within the space, the signal sensor being operatively connected to the electronic control unit for remotely operating the electronic control unit;
a first magnet integrated with the housing,
wherein the LED, battery, electronic control and solar panel are electrically self contained and have no electrical connection from inside the space to outside the space, and wherein the housing is configured to not have a position providing an opening connecting the space inside the housing to the outside space.

2. The illumination device of claim 1, wherein the infrared sensor is disposed behind the lens.

3. The illumination device of claim 1, wherein at least one LED is operable to emit a plurality of colors.

4. The illumination device of claim 3, further comprising:
a remote control to operate the infrared sensor to change the color of the at least one LED bulb.

5. The illumination device of claim 1, further comprising:
a remote control that is physically independent of the illumination device to operate the infrared sensor to remotely operate the electronic control unit.

6. The illumination device of claim 1, further comprising:
an on/off button for activating and deactivating the power source.

7. The illumination device of claim 1, further comprising:
a charge indicator light which changes colors to indicate different charges.

8. The illumination device of claim 1, wherein the lens is shaped to transmit light at an angle substantially perpendicular to a front surface of the lens.

9. The illumination device of claim 1, wherein the electronic control unit includes an electronic driver for regulating power from the power source to the at least one LED.

10. The illumination device of claim 1, further comprising:
a metal plate that is magnetically connectable to the first magnet, the metal plate being connectable to a solid object, thereby connecting the illumination device to the solid object.

11. The illumination device of claim 10, wherein the metal plate is magnetically connected to the first magnet and further connected to a solid object with epoxy adhesive.

12. The illumination device of claim 10, wherein the metal plate is magnetically connected to the first object and further connected to a solid object with glue.

13. The illumination device of claim 10, wherein the metal plate is magnetically connected to the first magnet and further connected to a solid object.

14. The illumination device of claim 1, wherein the lens is shaped so that light is transmitted at an angle substantially perpendicular to a front surface of the lens.

15. The illumination device of claim 1, wherein the lens includes a plurality of ridges distributed on the front surface of the lens, the ridges transmitting light at an angle substantially perpendicular to the front surface of the lens.

16. The illumination device of claim 1, wherein the housing forms an exterior surface that forms a single continuous outer surface.

17. The illumination device of claim 1, wherein the housing comprises a first outer housing part and a second outer housing part that are welded together to establish a continuous outer surface between the first outer casing part and the second outer casing part across and in the vicinity of the weld, thereby forming a housing whose entire outer surface has a continuous surface area.

18. The illumination device of claim 1, wherein the first outer casing part and the second outer casing part are glued together to establish a continuous outer surface between the first outer casing part and the second outer casing part across and in the vicinity of the weld, thereby forming a casing whose entire outer surface has a continuous surface area.

19. The illumination device of claim 1, wherein no openings for accessing the inside of the casing from the outside of the casing are provided.

20. The illumination device of claim 1, wherein no electrical connections are provided for electrically connecting to an electricity source outside the casing.

21. An illumination device, comprising:
a housing;
a lens disposed at an end of the housing, the lens being in a watertight engagement with the housing;
at least one LED disposed in the housing, the at least one LED for transmitting light through the lens;
a power source;
an electronic control unit for directing power from the power source to the at least one LED;
a magnet connected to the housing; and
an infrared sensor operatively connected to the electronic control unit for remotely operating the electronic control unit.
